(19) United States
(12) Patent Application Publication
(10) Pub. No.: US 2020/0340662 A1
(43) Pub. Date: Oct. 29, 2020

(54) Illuminated Vest

(71) Applicant: Michael Zorn, Kinnelon, NJ (US)

(72) Inventor: Michael Zorn, Kinnelon, NJ (US)

(21) Appl. No.: 16/502,816

(22) Filed: Jul. 3, 2019

Related U.S. Application Data
(60) Provisional application No. 62/838,841, filed on Apr. 25, 2019.

(51) Int. Cl. F21V 33/00; F21S 4/00; F21S 9/02; F21V 23/04; A41D 1/04; A41D 27/08; A41D 13/01

(52) U.S. Cl. CPC F21V 33/0012; F21S 4/00; F21S 9/02; F21Y 2115/00; A41D 1/04; A41D 27/085; A41D 13/01; F21V 23/0435

(57) ABSTRACT

An illuminated vest for use by an individual has been provided. The illuminated vest includes one or more batteries that are placed in one or more pockets of a transparent polyvinyl chloride (PVC) vest. The transparent PVC vest is constructed as two or more separate PVC vests with either heat sealed or sewn edges. Further, one or more light strands are encased inside the transparent PVC vest. A light control device controls the power supply from the one or more batteries to the one or more light strands based on an input provided by a user, and accordingly, turns ON or OFF the one or more light strands.

### CROSS-REFERENCE TO RELATED PATENT DOCUMENTS

This patent application claims the benefit of priority of U.S. Provisional Application No. 62/838,841, entitled “Illuminated Garments,” filed Apr. 25, 2019, which are hereby incorporated herein by reference in its entirety.

### FIELD OF THE INVENTION

The present disclosure generally relates to the field of safety vests, and more particularly, to a transparent vest including one or more light sources that illuminate light. The transparent vest is a safety vest that may be wearable by a child.

### BACKGROUND

Halloween festivities, particularly Trick-or-Treating, is a particularly exciting, though hazardous, event for children. Specifically, when children travel by foot out-of-doors along streets and sidewalks, after dark, they become very susceptible to an array of risks, the largest risk of course being hit by a car.

Parents and children may mitigate the risk by having the child carry some type of illumination, such as a flashlight. However, this method of illumination is far less effective than other types of bodily illumination that are in use by adults. Namely, electroluminescent or other lit stranding can be fashioned into a harness that provides constant, omnidirectional bodily illumination that can be worn by adults for activities such as night-time jogging or other situations where illumination provides a measure of safety.

Unfortunately, this type of illuminated harness is unsuitable for use by children, as items intended to be worn by children must specifically avoid providing any type of strangulation hazard—a hazard present in all harnesses made from illuminated stranding that are adapted for use by adults. Any such garment should meet the standards provided under 16 CFR 1120 and ASTM F 1816-97 in order to be deemed safe for garments sized between 2T and 12. Existing harnesses do not meet these standards, as they are comprised of strands that are wrapped around one's body—a practice that is patently unsafe for children.

Therefore, a need exists for a device for effectively bodily illuminating children, while mitigating the safety risks that may be presented by said illumination.

### SUMMARY

In an embodiment of the present disclosure, an illuminated vest for use by an individual has been provided. The illuminated vest is a transparent vest including one or more light sources that illuminate light. The transparent vest is a safety vest that may be wearable by an individual (such as a child) over a costume. The one or more light sources are encased in a transparent material.

In one embodiment of the present disclosure, the illuminated vest includes one or more batteries that are placed in one or more battery pockets of the transparent vest. The illuminated vest further includes one or more illuminated strand lights, such as light emitting diode (LED) or electroluminescent (EL) wire lights of one or more light strands that are encased within the transparent vest. The illuminated vest further includes a light control device for controlling power supply from the one or more batteries to the one or more light strands based on an input provided by a user who is wearing the transparent vest over a costume. The input may be provided to turn ON or turn OFF the one or more LED or EL wire lights of the one or more light strands. The controlling of the power supply comprises activating the one or more light strands to turn ON the one or more LED or EL wire lights, or deactivating the one or more light strands to turn OFF the one or more LED or EL wire lights.

In one embodiment of the present disclosure, the transparent vest is constructed of a transparent PVC material. The vest may include at least a transparent vest front portion, a transparent vest back portion, and the one or more battery pockets. Further, heat sealed edges are provided on outer edges of each of the transparent vest front portion, the transparent vest back portion, and the one or more battery pockets. The one or more light strands are encased inside the transparent vest front portion and the transparent vest back portion, when the transparent vest has been assembled together. The one or more battery pockets are located at a back hemline of the transparent vest.

In one embodiment of the present disclosure, the one or more LED or EL wire lights may be turned ON or OFF by the user using a physical switching device associated with the light control device. In another embodiment of the present disclosure, the one or more LED or EL wire lights may be turned ON or OFF by the user using a user computing device in a wireless manner over a network. In an embodiment, the one or more colors of the one or more LED or EL wire lights may be controlled based one or more inputs provided by the user.

The vest disclosed in the present invention is highly comfortable for the wearer. It facilitates optimal safety to the wearer, and importantly, eliminates potential strangulation hazards. The vest ensures minimal obstruction of the light intensity. The lights are securely sealed between layers of fabric to prevent them from being pulled out or becoming a hazard to the user. By encasing the light up wire in the clear PVC or other similar transparent material, the costume is fully visible. The vest has been designed to have virtually no adjustment and be sized for the child. The vest allows light to pass for safety, and allow costume to be viewed without obstruction. The lights may be configured differently, be different colors, or vary in volume of lights.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates schematic line diagrams of various cut-outs of a transparent polyvinyl chloride (PVC) vest, in accordance with an embodiment of the present disclosure;

FIG. 2 shows schematic line diagrams of various views of the transparent PVC vest, in accordance with an embodiment of the present disclosure;

FIG. 3 is a schematic diagram of the transparent PVC vest illustrating lighting sources embedded within a PVC vest front portion and a PVC vest back portion of the transparent PVC vest, in accordance with an embodiment of the present disclosure;

FIG. 4 is a schematic diagram of the transparent PVC vest illustrating a light strand encased within the PVC vest front portion and the PVC vest back portion of the transparent PVC vest that is placed over an exemplary user body, in accordance with an embodiment of the present disclosure;

FIG. 5 is a schematic diagram of the transparent PVC vest illustrating illuminated lighting sources such as the light strand encased within the PVC vest front portion and the PVC vest back portion of the transparent PVC vest that is placed over the exemplary user body, in accordance with an embodiment of the present disclosure;

FIG. 6 is a schematic diagram of a front view of a user wearing the transparent PVC illuminated vest, in accordance with an embodiment of the present disclosure;

FIG. 7 is a schematic diagram of a rear view of the user wearing the transparent PVC illuminated vest, in accordance with an embodiment of the present disclosure; and

FIG. 8 is a schematic block diagram of a communication environment for controlling ON-OFF of one or more LED or EL wire lights of one or more light strands such as the light strand encased with in the transparent PVC vest, in accordance with an embodiment of the present disclosure.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional components described in the foregoing application that are not depicted in one of the described drawings. In the event such a component is described, but not depicted in a drawing, the absence of such a drawing should not be considered as an omission of such design from the specification.

Before describing the present invention in detail, it should be observed that the present invention utilizes a combination of components which constitutes an illuminated safety vest for use by an individual. Accordingly, the components and the method steps have been represented, illustrating only specific details that are pertinent for an understanding of the present invention so as not to obscure the disclosure with details that will be readily apparent to those with ordinary skill in the art having the benefit of the description herein.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

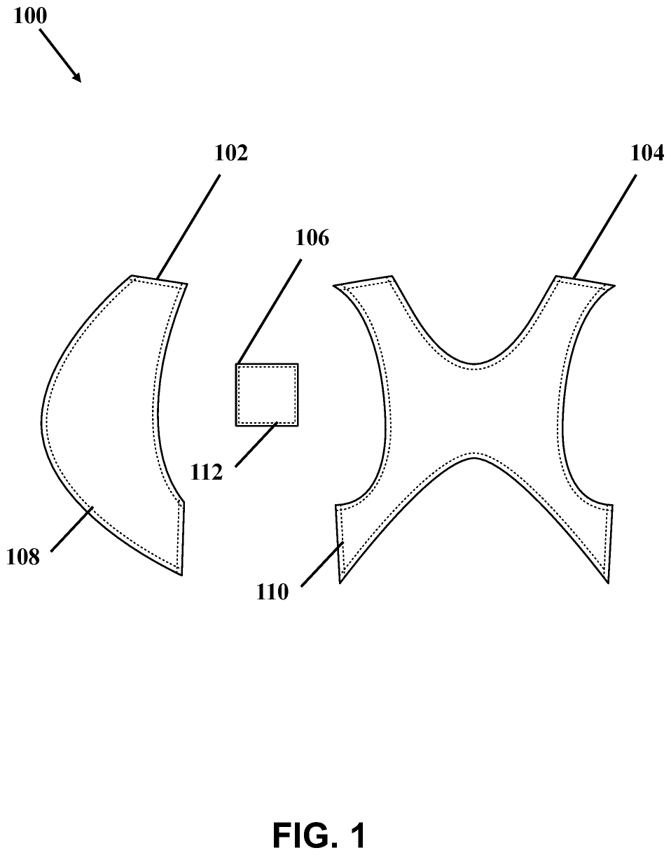

Referring now to FIG. 1, schematic line diagrams of various cut-outs of a transparent polyvinyl chloride (PVC) vest 100 has been shown, in accordance with an embodiment of the present disclosure. The transparent PVC vest 100 may be constructed as two or more separate PVC vests with either heat sealed or sewn edges. For example, the various cut-outs of the transparent PVC vest 100 includes at least a first PVC vest front portion and a second PVC vest front portion (such as a PVC vest front portion 102), a PVC vest back portion 104, and a pocket 106. The various cut-outs may be sewed together to form the transparent PVC vest 100. In one example, the transparent PVC vest 100 may be a pull over vest that can be worn by an individual through the head. In another example, the transparent PVC vest 100 may include Velcro closure in the form of a hook or a loop. In another example, the transparent PVC vest 100 may also include a snap closure. In another example, the transparent PVC vest is a pullover, and no closure method is required. In another example, the transparent PVC vest is open at the front and does not include a closure means.

In an embodiment, the PVC vest front portion 102, the PVC vest back portion 104, and the pocket 106 may be formed by using the plastic polyvinyl chloride having transparent characteristics. More specifically, the PVC vest front portion 102, the PVC vest back portion 104, and the pocket 106 may be made up of 12-gauge PVC vinyl.

In an embodiment, for each of the PVC vest front portion 102, the PVC vest back portion 104, and the pocket 106, heat sealed edges are preferred. For example, as shown in FIG. 1, a heat sealed edge 108 is preferred for the PVC vest front portion 102, a heat sealed edge 110 is preferred for the PVC vest back portion 104, and a heat sealed edge 112 is preferred for the pocket 106. The above heat sealed edges may be preferred on the outer edges of the PVC vest front portion 102, the PVC vest back portion 104, and the pocket 106, as shown in FIG. 1.

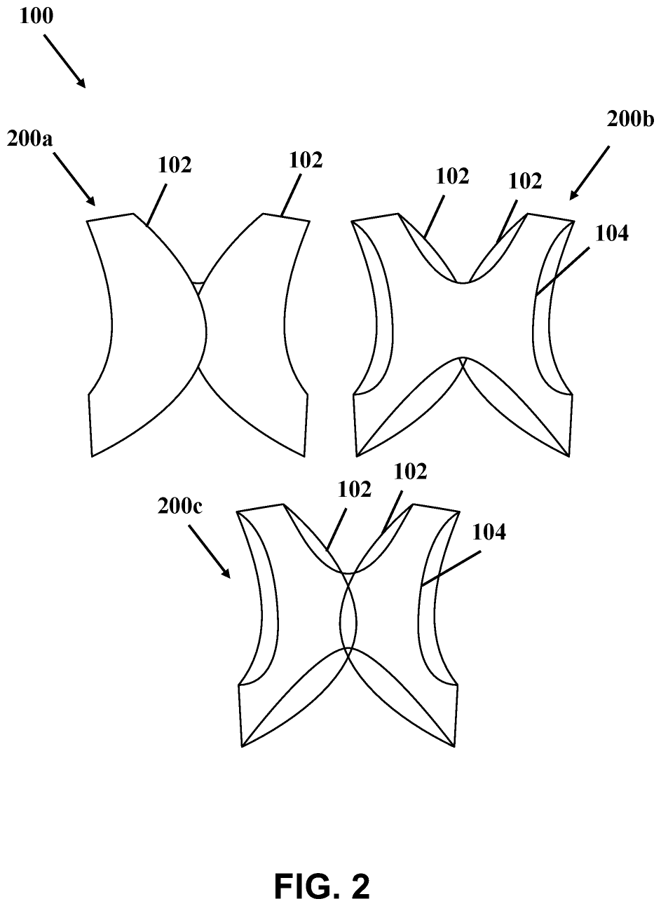

FIG. 2 shows schematic line diagrams of various views of the transparent PVC vest 100, in accordance with an embodiment of the present disclosure. More specifically, FIG. 2 shows the design of the transparent PVC vest 100. For example, as shown in FIG. 2, a first view 200a illustrates a front view or portion of the transparent PVC vest 100. The first view 200a shows the PVC vest front portion 102 such as the first PVC vest front portion and the second PVC vest front portion that have been sewed together. Further, as shown in FIG. 2, a second view 200b illustrates a rear view of the transparent PVC vest 100. The second view 200b shows the PVC vest front portion 102 (such as the first PVC vest front portion and the second PVC vest front portion) and the PVC vest back portion 104 that have been sewed together. Further, as shown in FIG. 2, a third view 200c illustrates a transparent view of the transparent PVC vest 100.

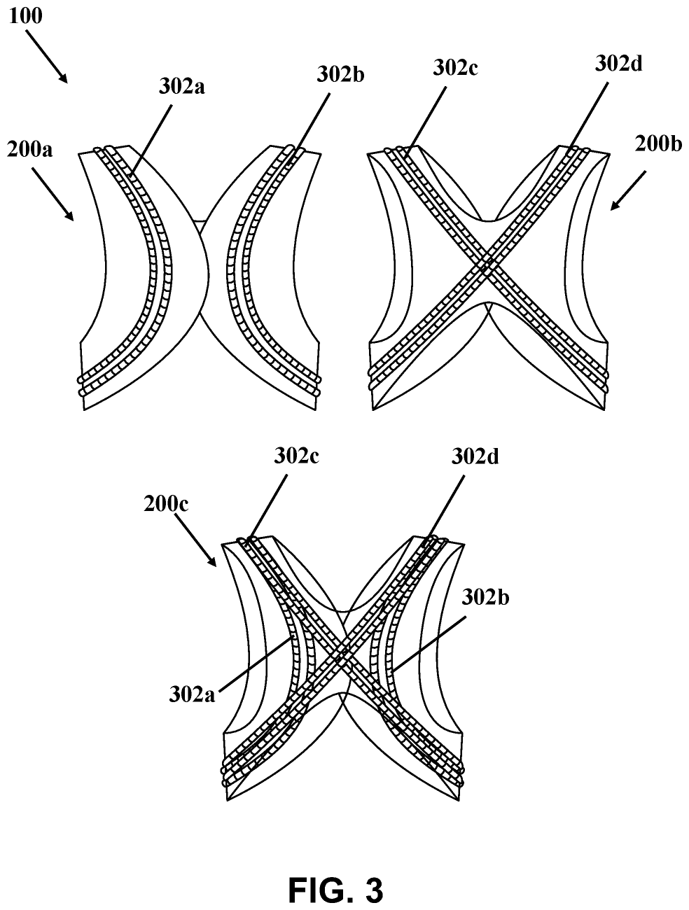

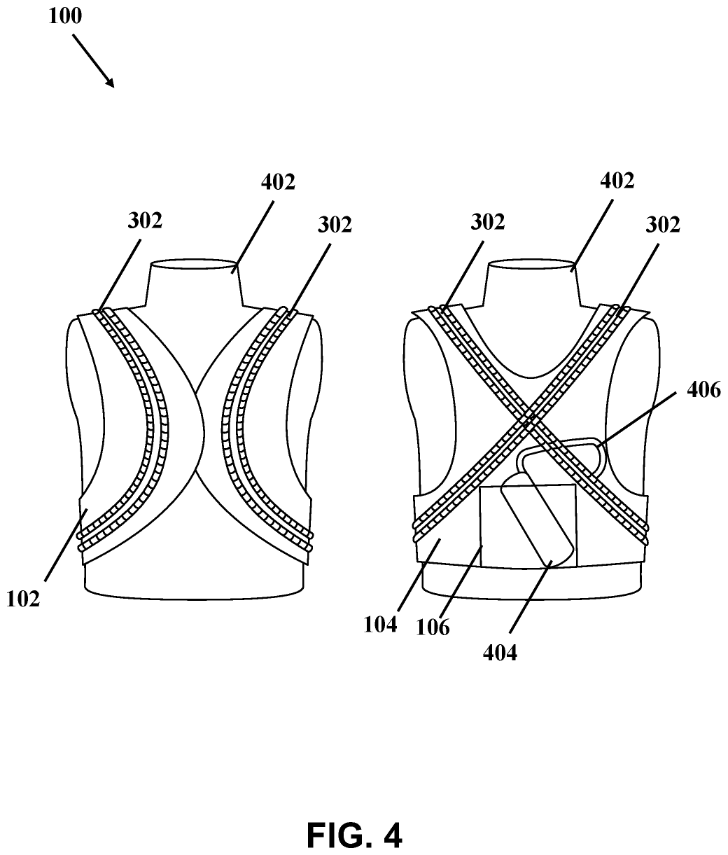

FIG. 3 is a schematic diagram of the transparent PVC vest 100 illustrating lighting sources embedded within the PVC vest front portion 102 and the PVC vest back portion 104, in accordance with an embodiment of the present disclosure. The PVC vest front portion 102 and the PVC vest back portion 104 may be encased with one or more lighting sources (for example, one or more light emitting diode (LED) lights or electroluminescent (EL) wire lights). The one or more LED or EL wire lights may be used in the form of one or more light strands such as at least one of a first light strand 302a, a second light strand 302b, a third light strand 302c, and a fourth light strand 302d. In one specific embodiment of the present invention, the first light strand 302a may be encased or embedded within the first PVC vest front portion and the second light strand 302b may be encased or embedded within the second PVC vest front portion, as shown in the first view 200a (i.e., the front view) and the third view 200c (i.e., the transparent view) of the transparent PVC vest 100. Further, the third light strand 302c and the fourth light strand 302d may be encased or embedded within the PVC vest back portion 104, as shown in the second view 200b (i.e., the front view) and the third view 200c (i.e., the transparent view) of the transparent PVC vest 100. In some applications, a single light strand may be encased or embedded within the PVC vest front portion 102 (such as the first PVC vest front portion and the second PVC vest front portion) and the PVC vest back portion 104. Hereinafter, the first light strand 302a, the second light strand 302b, the third light strand 302c, and the fourth light strand 302d may be collectively or individually referred to as a light strand 302 (as shown in FIG. 4).

In FIG. 3, the one or more light strands (of the one or more LED or EL wire lights) integrated within the PVC vest front portion 102 and the PVC vest back portion 104 have been shown in an OFF state, where the one or more LED or EL wire lights are not illuminating any light. The one or more LED or EL wire lights may be illuminated by powering them using a power source, for example, one or more batteries. Each battery may be a chargeable battery or a replaceable battery. For illuminating, the one or more LED or EL wire lights (or the one or more light strands) are electrically connected to the one or more batteries and are powered by them. The one or more batteries may be placed inside one or more battery pockets (such as the pocket 106) of the transparent PVC vest 100 for facilitating electrical power to the one or more LED or EL wire lights. For example, a battery may be placed in a battery pocket (such as the pocket 106) that is located at a back hemline of the transparent PVC vest 100.

In an embodiment, the transparent PVC vest 100 may also include an light control device (not shown) that may be used by an individual (for example, a wearer of the transparent PVC vest 100) to control an operating or working state (for example, turning ON or turning OFF) of the one or more LED or EL wire lights. The light control device may also be placed inside one of the one or more pockets (such as the pocket 106) of the transparent PVC vest 100 that is easily accessible by the individual. For example, the light control device may be placed in a pocket (such as the pocket 106) that is located in the PVC vest front portion 102. In one example, the light control device may be physically used by the individual to turn ON or turn OFF the one or more LED or EL wire lights. In another example, the light control device may be wirelessly connected or coupled to a mobile computing device (for example, a smartphone) of the individual. In such a scenario, the individual may utilize the mobile computing device to turn ON or turn OFF the one or more LED or EL wire lights. In a scenario where the one or more LED or EL wire lights are of different colors, the individual may utilize the mobile computing device to change one or more colors of the one or more LED or EL wire lights.

FIG. 4 is a schematic diagram of the transparent PVC vest 100 illustrating the light strand 302 encased within the PVC vest front portion 102 and the PVC vest back portion 104 of the transparent PVC vest 100 that is placed over an exemplary user body 402, in accordance with an embodiment of the present disclosure. As shown, the light strand 302 is encased within the PVC vest front portion 102 and the PVC vest back portion 104 of the transparent PVC vest 100. Further, there is shown the pocket 106 that houses the one or more batteries such as a battery 404 that is electrically connected to the light strand 302 by means of an electrical wire 406. The pocket 106 may also include the light control device (not shown) that may be used for changing the operating or working state of the light strand 302. Here, in FIG. 4, the light strand 302 (of the one or more LED or EL wire lights) has been shown in an OFF state, where the one or more LED or EL wire lights are not illuminating any light. The one or more LED or EL wire lights may be illuminated by powering them using the battery 404.

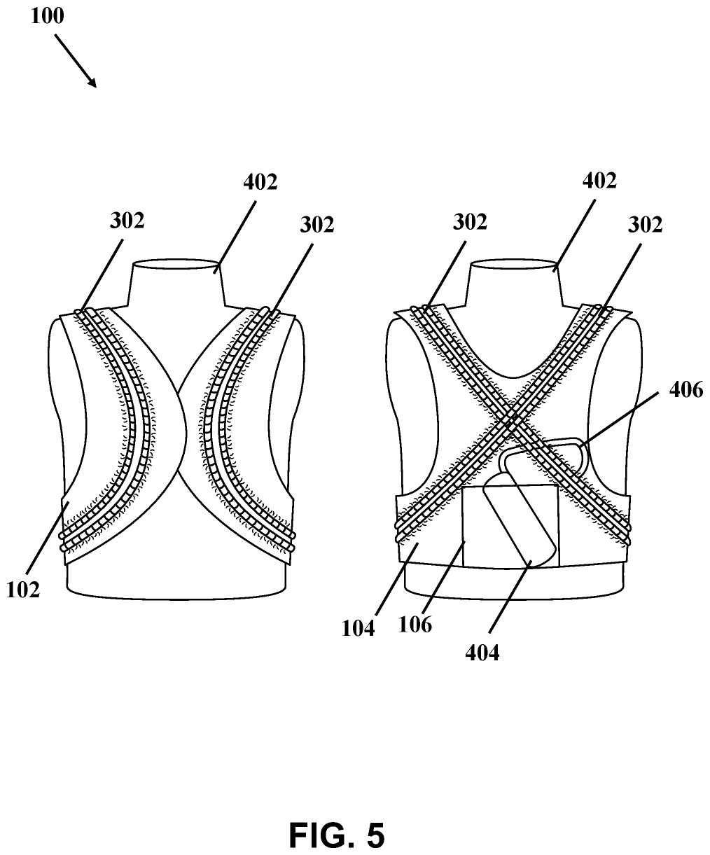

FIG. 5 is a schematic diagram of the transparent PVC vest 100 illustrating illuminated lighting sources such as the light strand 302 encased within the PVC vest front portion 102 and the PVC vest back portion 104 of the transparent PVC vest 100 that is placed over the exemplary user body 402, in accordance with an embodiment of the present disclosure. The light strand 302 (of the one or more LED or EL wire lights) may be illuminated when the individual (i.e., the wearer) turns ON the one or more LED or EL wire lights by turning ON the one or more batteries (such as the battery 404) to supply the electrical power to the light strand 302. The individual may turn ON the one or more LED or EL wire lights either physically by using one or more switches provided with the light control device, or wirelessly by using the mobile computing device that is wirelessly communicating with the light control device.

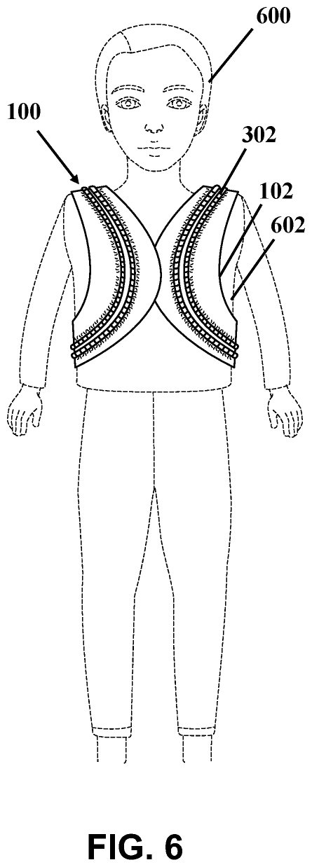

FIG. 6 is a schematic diagram of a front view of a user 600 wearing the transparent PVC illuminated vest 100, in accordance with an embodiment of the present disclosure. In FIG. 6, the user 600 is shown wearing the illuminated vest 100 over his costume 602. Here, the same light control device (not show) may be used to control the ON or OFF of the one or more LED or EL wire lights of the light strand 302 encased within the PVC vest front portion 102. As shown, when the user 600 has turned ON the power supply to the one or more LED or EL wire lights from the one or more batteries, the one or more LED or EL wire lights of the light strand 302 encased within the vest 100 are illuminated. The user 600 may also control the one or more colors of the one or more LED or EL wire lights. At any given time, the one or more LED or EL wire lights may be illuminated in the same color or different colors based on the preferences of the user 600. Further, the light control device may also include a mechanism that facilitates flashing or blinking of the one or more LED or EL wire lights in a sequence of ON-OFF pattern.

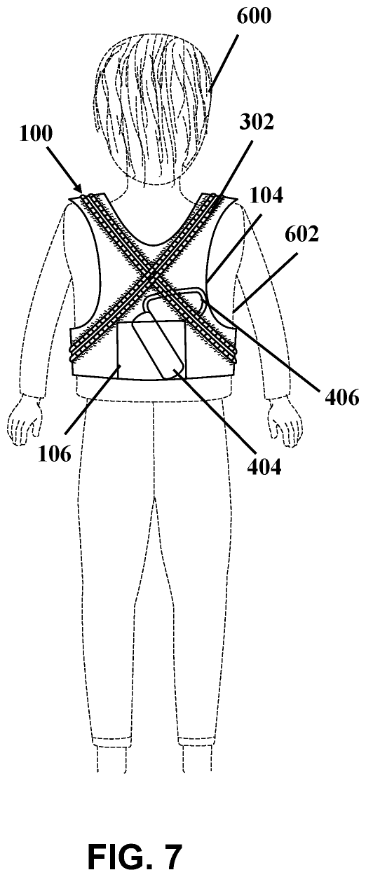

FIG. 7 is a schematic diagram of a rear view of the user 600 wearing the transparent PVC illuminated vest 100, in accordance with an embodiment of the present disclosure. In FIG. 7, the user 600 is shown wearing the illuminated vest 100 over his costume 602. Here, the same light control device (not show) may be used to control the ON or OFF of the one or more LED or EL wire lights of the light strand 302 encased within the PVC vest back portion 104. As shown, when the user 600 has turned ON the power supply to the one or more LED or EL wire lights from the one or more batteries such as the battery 404, the one or more LED or EL wire lights of the light strand 302 encased within the vest 100 are illuminated. The user 600 may also control the one or more colors of the one or more LED or EL wire lights. At any given time, the one or more LED or EL wire lights may be illuminated in the same color or different colors based on the preferences of the user 600. Further, the light control device may also include a mechanism that facilitates flashing or blinking of the one or more LED or EL wire lights in a sequence of ON-OFF pattern.

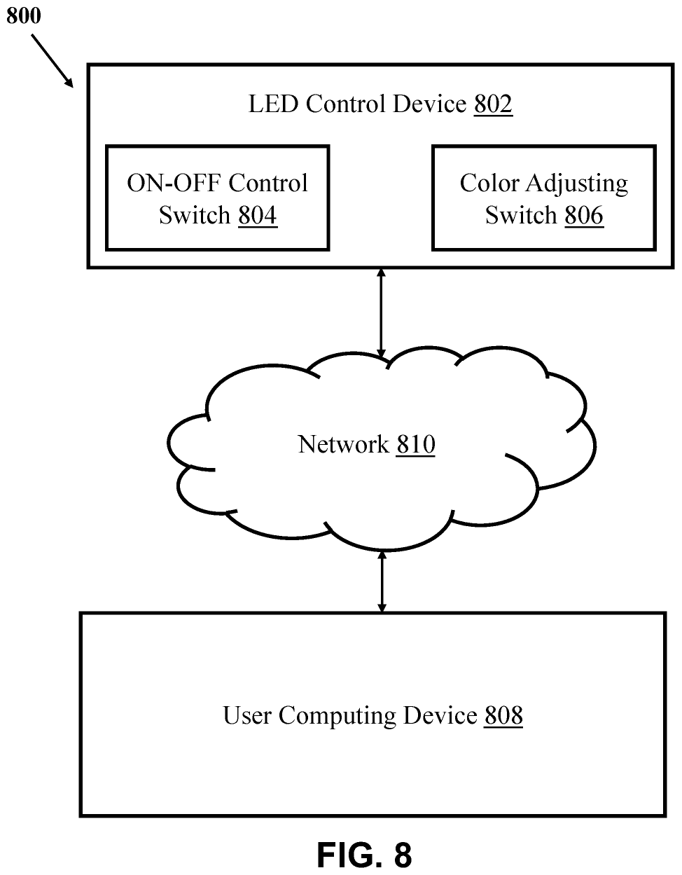

FIG. 8 is a schematic block diagram of a communication environment 800 for controlling ON-OFF of the one or more LED or EL wire lights of the one or more light strands such as the light strand 302 encased with in the transparent PVC vest 100, in accordance with an embodiment of the present disclosure. The communication environment 800, for simplicity of the ongoing discussion, shows the light control device 802 and the user computing device 808 that communicate with each other over a network 810. The light control device 802 also includes an ON-OFF control switch 804 and a color adjusting switch 806.

Various components of the communication environment 800 are capable of connecting to the Internet. It should be noted that the term “Internet” is intended to encompass similar systems as well (i.e., World Wide Web or “www”) comprising the capability to communicate and access information through the network 810. Examples of types of the network 810 may include, but are not limited to, a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), an enhanced data GSM environment (EDGE) and a Universal Mobile Telecommunications System (UMTS). The present invention should not be limited in its communication nomenclature.

In an embodiment, the light control device 802 may include suitable logic, circuitry, interfaces, and/or code, executable by the circuitry that may be configured to perform one or more predefined operations. The light control device 802 may be a computing device or application, which may include a software framework that may be configured to create an application implementation and perform the various predefined operations based on one or more inputs initiated by the user 600. For example, the light control device 802 may be used to control ON-OFF of the one or more LED or EL wire lights by controlling the power supply from the one or more batteries (such as the battery 404). The light control device 802 may also be used to control the one or more colors of the one or more LED or EL wire lights, either simultaneously or one at a time.

The light control device 802 may be realized through various web-based technologies, such as, but not limited to, a Java web-framework, a .NET framework, a professional hypertext pre-processor (PHP) framework, a python framework, or any other web-application framework. The light control device 802 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the light control device 802 may include, but are not limited to, a personal computer, a laptop, or a network of computer systems.

In an embodiment, the ON-OFF control switch 804 may be an electrical switch, an electronic switch, a mechanical switch, or a combination thereof that is operated to activate or deactivate the one or more batteries, which in turn activate or deactivate the one or more LED or EL wire lights, respectively. For example, when the ON-OFF control switch 804 is activated (turned ON) by the user 600, the electrical power is supplied or transferred from the one or more batteries (such as the battery 404) to the one or more LED or EL wire lights, and thus the one or more LED or EL wire lights are activated i.e., turned ON, and hence illuminate lights in the one or more colors, for example, white color. In another example, when the ON-OFF control switch 804 is deactivated (turned OFF) by the user 600, the electrical power is not supplied or transferred from the one or more batteries (such as the battery 404) to the one or more LED or EL wire lights, and thus the one or more LED or EL wire lights are deactivated i.e., turned OFF, and hence does not illuminate light. In an embodiment, the ON-OFF control switch 804 may be physically operated by the user 600 for its activation or deactivation. In another embodiment, the ON-OFF control switch 804 may be wirelessly operated by the user 600 by using the user computing device 808 over the network 810. The user 600 may utilize an application running on the user computing device 808 to initiate one or more commands such as an activation command or a deactivation command to activate (turn ON) or deactivate (turn OFF) the one or more LED or EL wire lights.

In an embodiment, the color adjusting switch 806 may be an electrical switch, an electronic switch, a mechanical switch, or a combination thereof that is operated to select the one or more colors of illumination of the one or more LED or EL wire lights. For example, in a default mode of the color adjusting switch 806, the one or more LED or EL wire lights may illuminate lights in the white color. In a first mode of the color adjusting switch 806, the one or more LED or EL wire lights may illuminate lights in another color such as red color. Similarly, in a second mode of the color adjusting switch 806, the one or more LED or EL wire lights may illuminate lights in another color such as green color, and so on. In an embodiment, the color adjusting switch 806 may be physically operated by the user 600 for selecting various modes of operations. In another embodiment, the color adjusting switch 806 may be wirelessly operated by the user 600 by using the user computing device 808 over the network 810. The user 600 may utilize an application running on the user computing device 808 to initiate one or more commands such as a first mode command or a second mode command to switch the one or more colors of the one or more LED or EL wire lights.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. An illuminated vest, comprising:
one or more batteries that are placed in one or more battery pockets of a transparent vest;
one or more illuminated strand wire lights of one or more light strands encased within or attached to the transparent vest; and
a light control device for controlling power supply from the one or more batteries to the one or more light strands based on an input provided by a user who is wearing the transparent vest over a costume, to turn ON or turn OFF the one or more illuminated strand wire lights of the one or more light strands, wherein the controlling of the power supply comprises:
activating the one or more light strands to turn ON the one or more illuminated strand wire lights, or
deactivating the one or more light strands to turn OFF the one or more illuminated strand wire lights.

2. The illuminated vest of claim 1, wherein the illuminated strand wire lights are one of either light emitting diode (LED) or electroluminescent (EL) wire lights.

3. The illuminated vest of claim 2, wherein the transparent vest is a transparent PVC vest.

4. The illuminated vest of claim 3, wherein the transparent PVC vest constructed as two separate vests.

5. The illuminated vest of claim 4, wherein the two separate vests are joined with either heat sealed or sewn edges.

6. The illuminated vest of claim 4, wherein the transparent PVC vest includes at least a PVC vest front portion, a PVC vest back portion, and the one or more battery pockets, and wherein heat sealed edges are provided on outer edges of each of the PVC vest front portion, the PVC vest back portion, and the one or more battery pockets.

7. The illuminated vest of claim 6, wherein the one or more light strands are encased inside the PVC vest front portion and the PVC vest back portion, when the transparent PVC vest is assembled together.

8. The illuminated vest of claim 3, wherein the one or more battery pockets are located at a back hemline of the transparent PVC vest.

9. The illuminated vest of claim 3, wherein the transparent PVC vest includes at least a Velcro closure or a snap closure.

10. The illuminated vest of claim 3, wherein the one or more LED or EL wire lights are turned ON or OFF by the user using a physical switching device associated with the light control device.

11. The illuminated vest of claim 3, wherein the one or more LED or EL wire lights are turned ON or OFF by the user using a user computing device in a wireless manner over a network, wherein the user computing device is communicatively coupled to the light control device over the network.

12. The illuminated vest of claim 3, further comprising controlling one or more colors of the one or more LED or EL wire lights based one or more inputs provided by the user.
